(19) United States
(12) Patent Application Publication
(10) Pub. No.: US 2005/0125284 A1
(43) Pub. Date: Jun. 9, 2005

(54) Systems, methods and computer program products for selecting and assigning parking

(75) Inventor: David R. Fairbaugh, Charlotte, NC (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Preferred Parking Service, Inc.

(21) Appl. No.: 10/731,883

(22) Filed: Dec. 9, 2003

(51) Int. Cl. G06F 17/60

(52) U.S. Cl. 705/13

(57) ABSTRACT

The system includes a data repository, a user interface having a display, and a controller interfacing with the data repository and the user interface. The controller comprises a retrieval module structured to retrieve data from the data repository, a processing module structured to process the data, a display module structured to display the processed data in the form of an interactive map on the display of the user interface whereby the user can selectively request geographical information for parking and the adjacent locale to enable the user to select parking.

### FIELD OF THE INVENTION

The present invention relates to systems, methods, and computer program products for selecting and assigning parking.

### BACKGROUND OF THE INVENTION

It is quite common for employees to have to obtain a permit to park a motorized vehicle at or near their place of employment, particularly in urban areas. Such permits are generally monthly or yearly permits and authorize the owner to park a motorized vehicle in an authorized parking area, such as a specific lot or lots and, in some instances, a specific space. The process of selecting and assigning parking generally requires a customer to appear in-person, or to contact the owner of the parking area via telephone or via written correspondence. Similarly, customers generally have the option of paying for the assigned parking in-person or by mailing their payment to the owner of the parking area. With the growth of electric commerce, many parking area owners have begun providing customers with the option to pay for assigned parking via a computer network, such as the Internet. For example, customers can arrange for an automatic draft of the customer's bank account or for payment through a credit card or debit card.

However, because the process of selecting and assigning parking still generally requires the customer to appear in-person or to contact the owner of the parking area via telephone or via written correspondence, this process can be time consuming and can result in delays in selecting the desired parking and/or in obtaining a parking assignment. Consequently, there remains a need for a method and system to enable a user to efficiently select parking and for the parking area owner to assign the parking to the customer.

### SUMMARY OF THE INVENTION

The present invention provides systems, methods and computer program products for selecting and assigning parking. According to one embodiment, the system includes a data repository, a user interface having a display, and a controller interfacing with or in operable communication with the data repository and the user interface. The controller comprises a retrieval module structured to retrieve data from the data repository, a processing module structured to process the data, a display module structured to display the processed data in the form of an interactive map on the display of the user interface whereby the user can selectively request geographical information for parking and the adjacent locale to enable the user to select parking. According to one embodiment, the interactive map comprises user-activated menus containing corresponding geographical information. According to another embodiment, the display module is structured to display payment options comprising at least one of bank account drafting or credit card processing.

According to another embodiment, the system comprises a processing element capable of generating and displaying an interactive map containing available parking for selection by a user. The processing element also is capable of receiving data corresponding to the parking selected by the user, and wherein the processing element is further capable of assigning parking to the user. In one embodiment, the interactive map comprises user-activated menus containing corresponding geographical information.

According to another embodiment, the system comprises a processing element capable of receiving a request from a user for selected geographical information. The processing element is capable of retrieving data corresponding to the selected geographical information. The processing element also is capable of processing the data according to predetermined parameters. The processing element is further capable of generating and displaying the requested geographical information as a component of an interactive map to enable the user to select parking.

In one embodiment, the processing element is capable of displaying payment options comprising at least one of bank account drafting and credit card processing. In another embodiment, the processing element is capable of receiving data corresponding to the payment option selected by the user, and also is capable of processing the payment. In yet another embodiment, the processing element is capable of issuing the user a temporary parking permit.

The present invention also provides a method of selecting and assigning parking. According to one embodiment, the method includes receiving a request electronically from a user interface for information corresponding to at least one of location of parking, pricing for parking and availability of parking. Data corresponding to the requested information is retrieved from a data repository. The data is processed according to predetermined parameters. An interactive map is generated based at least in part upon the processed data. The interactive map is displayed at the user interface to enable a user to select parking.

In one embodiment, the method includes receiving a request electronically for geographical information. Data corresponding to the requested geographical information is retrieved from a data repository. The data is processed according to predetermined parameters. The requested geographical information is displayed at the user interface as a component of the interactive map.

In still other embodiments, the method comprises displaying payment options to the user at the user interface. The user's payment selection is received. The user's payment selection is then processed. In one embodiment, the user is assigned the selected parking. In another embodiment, the user is provided with a temporary parking permit.

According to another embodiment, the method includes receiving a request electronically from a user interface for selected geographic information. Geographical data is retrieved electronically from a data repository. The data is processed according to predetermined parameters. The requested geographical information is displayed at least one user interface as a component of an interactive map. According to still another embodiment, the method includes displaying payment options to the user on the display. Thereafter, the user's payment selection is received and processed.

According to another embodiment, the invention provides a computer program product for facilitating the selection and assignment of parking. The computer program product comprises a computer-readable storage medium having computer-readable program code portions stored therein. The computer-readable program portions comprise an executable portion for generating and displaying an interactive map containing available parking for selection by a user. The executable portion receives data corresponding to the parking selected by the user, and wherein said executable portion assigns parking to the user. In one embodiment, the interactive map comprises user- activated menus containing corresponding geographical information.

In another embodiment, the executable portion receives a request from a user for selected geographical information. The executable portion retrieves data corresponding to the selected geographical information. The executable portion processes the data according to predetermined parameters. The executable portion generates and displays the requested geographical information as a component of an interactive map to enable the user to select parking.

In yet another embodiment, the executable portion displays payment options comprising at least one of bank account drafting and credit card processing. In yet another embodiment, the executable portion receives data corresponding to the payment option selected by the user, and processes the payment. In another embodiment, the user is provided with a temporary parking permit.

Thus, there is provided a method and system to enable a user to efficiently select parking and for the parking area owner to assign the parking to the customer.

### BRIEF DESCRIPTION OF THE DRAWINGS

The foregoing and other advantages and features of the invention, and the manner in which the same are accomplished, will become more readily apparent upon consideration of the following detailed description of the invention taken in conjunction with the accompanying drawings, which illustrate preferred and exemplary embodiments, and which are not necessarily drawn to scale, wherein:

FIG. 1 is a block diagram illustrating the components of a system for selecting and assigning parking, according to one embodiment of the present invention;

FIG. 2 is a block diagram illustrating the components of a system for selecting and assigning parking, according to another embodiment of the present invention;

FIG. 3 is diagram illustrating an embodiment of a graphical display generated and displayed by the display module in order to solicit information from a user through the user interface;

FIGS. 4-34 are diagrams illustrating interactive maps generated and displayed on the display of a user interface by the display module, whereby the user can selectively request geographical information relative to available parking and the adjacent locale to enable the user to select parking, according to embodiments of the present invention; and

FIG. 35 is a block diagram illustrating a method for selecting and assigning parking, according to one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

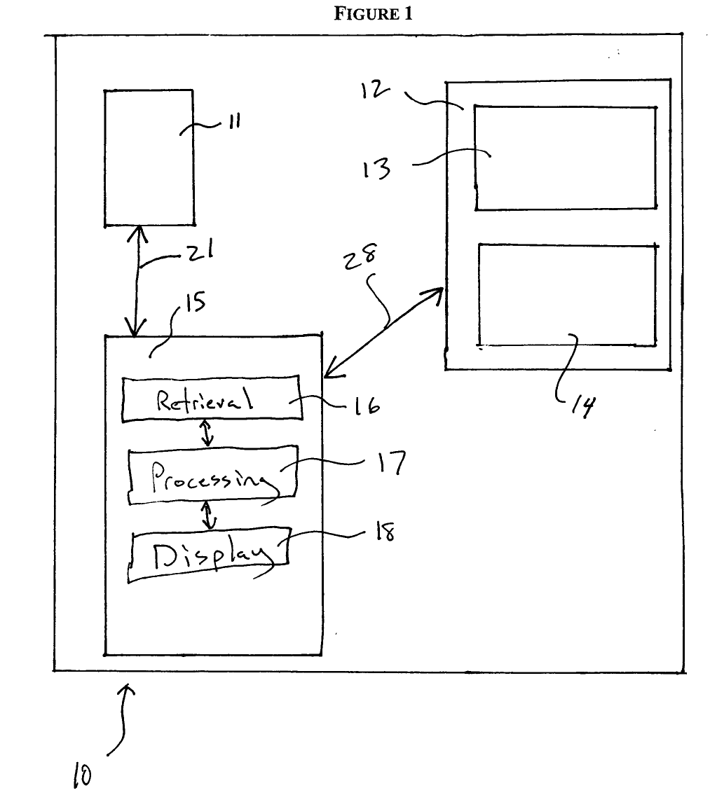

Referring to the drawings and, in particular to FIG. 1, there is illustrated a system 10 for selecting and assigning parking, according to one embodiment of the present invention. The system 10 includes a data repository 11 structured to store data in computer-readable memory; at least one user interface 12 having a display 13; and a controller 15 in operable communication with the data repository and the user interface.

The data repository 11 is structured to store in computer-readable memory data corresponding to predetermined geographical locations (such as cities, towns, airports, marinas, train stations, commuting terminals, etc.), geographical areas within each geographical location (such as intersections of streets, buildings, etc.), other predetermined geographical data, the location of parking, pricing or fees for parking, and other related information, including, by way of example and not for purposes of limitation, the lot number for each parking area, the lot location, the number of spaces available, the names of landmark buildings and other structures, compass directional arrows, street names, street directional arrows, rules and regulations for the parking areas, contact information for the owner of the parking area (such as the owner's name, address, telephone number, facsimile number, and/or electronic mail address), customer contact information (such as the customer's name, address, telephone number, facsimile number, electronic mail address, and/or login information (such as username and password)), and information about special-event parking. In one embodiment, the data repository 11 comprises a computer, processor or microprocessor operating under software control.

The data stored by the data repository 11 can be entered manually by the parking area owner or an employee using a keyboard, mouse, scanner or other input device, as is known in the art. For example, the data can be entered periodically by the parking area owner during the normal course of business for accounting or billing purposes, or can be entered by the parking area owner in response to a specific inquiry from the controller 15 detailing the desired data. In one embodiment, the data repository 11 can include a data capture or data mining module (not shown). Advantageously, the data capture module can be instructed to automatically capture and compile the desired data in a form that can be subsequently transferred to the controller 15, as described below. The data repository 11 is preferably located at the parking area owner's premises, although the data repository can also be maintained at another location, such as at a network provider's data center.

The user interface 12 of the system 10 preferably comprises a controller 14, such as a computer, processor, or microprocessor operating under software control. The user interface 12 includes a display or monitor 13. The controller 14 and display 13 are preferably structured to support applications or software for generating complex graphics, i.e., the controller has sufficient memory and a processor with sufficient processing speed to process graphics output.

The controller 15 comprises a computer, processor, server or microprocessor operating under software control. Preferably, the controller 15 includes hardware (not shown) and associated software for data storage. In one embodiment, the controller 15 comprises at least one retrieval module 16 structured to retrieve (i.e., request and receive) data from the data repository 11 and to communicate data to the data repository for storage. The controller 15 also comprises at least one processing module 17 in operable communication with the retrieval module 16 and being structured to process, based on predetermined parameters, the data retrieved by the retrieval module from the data repository 11 and/or the data to be transmitted by the retrieval module to the data repository for storage. The controller 15 also comprises at least one display module 18 in operable communication with the processing module 17 and the user interface 12 and being structured to generate and display an interactive map and other graphical displays through which a user can selectively request geographical information relative to parking and the adjacent locale to enable the user to select and be assigned parking.

The retrieval module 16 of the controller 15 preferably is in communication with the data repository 11 through a secure data link 21 so that the retrieval module can retrieve data from the data repository and communicate data to the data repository for storage. The data link 21 can be either electrical or optical and can include, by way of example and not for purposes of limitation, a satellite or other wireless connection, the Internet or world wide web, a local area network or LAN, a wide area network or WAN, an Intranet, or an Extranet. According to one embodiment, the data repository 11 includes a data capture module that captures and compiles the desired data or information contained in the data repository. According to this embodiment, the retrieval module 16 is structured to retrieve the data from the data repository 11 by communicating periodically with the data capture module over the secure data link 21. The data retrieved from the data repository 11 by the retrieval module 16 can be stored locally by the controller 15 in computer-readable memory.

The security of the secure data link 21 can be provided and maintained using network security capabilities such as intrusion detection, content screening, URL blocking and bandwidth management. Examples of network security capabilities include network protection software, Internet security software, network firewall technology, VPN (virtual private network) technology, secured messaging software (i.e., encryption), and URL filtering systems, as is known in the art.

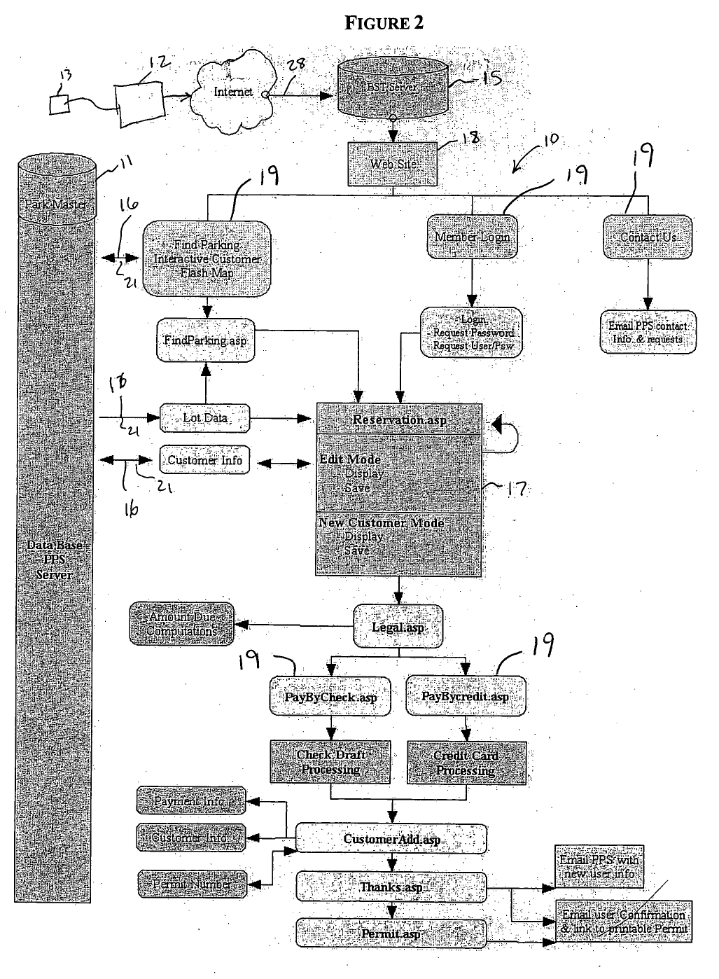

As illustrated in FIG. 1, the controller 15 includes at least one processing module 17 for processing the data that is retrieved from the data repository 11 by the retrieval module 16 and/or the data to be transmitted by the retrieval module to the data repository for storage. The processing module 17 processes the data based upon predetermined parameters, depending on what function is being performed by the system 10. For example, if the user transmits instructions through the user interface 12 requesting information on parking in specified geographic areas within a specified geographic location, the processing module 17 is structured to process or analyze the data retrieved from the data repository 11 by the retrieval module 16, such as by comparing, sorting, categorizing, and/or grouping the data as specified by the user. According to another embodiment, if the user transmits data corresponding to payment information (such as a credit card no., expiration date, billing address, etc.) or other instructions or requests through the user interface 12, the processing module 17 is structured to receive and process the data, for example, by computing and processing the payment through the appropriate financial institution, or by communicating the user's instructions or request for information to the retrieval module 16 for fulfillment. According to one embodiment of the system 10, as illustrated in FIG. 2, the processing module 17 can compute the payment and process the payment via check draft or credit card. The databases and modules of the controller 15 are interconnected and interface together through the processing module 17. In one embodiment, the retrieval module 16 can comprise the processing module 17. In another embodiment, the display module 18 can comprise the processing module 17.

As illustrated in FIG. 1, the display module 18 is connected to the user interface 12 by a data link 28, which can be secured or unsecured. The data link 28 can be either electrical or optical and can include, by way of example and not for purposes of limitation, a satellite or other wireless connection, the Internet or world wide web, a local area network or LAN, a wide area network or WAN, an intranet, or an extranet. For example, as illustrated in FIG. 2, the controller 15 and display module 18 may be resident at the network provider's data center while the user interface 12 is located remotely. According to this embodiment, the user can access the display module 18 through the user interface 12 in several ways, for example, by contacting the network provider's data center directly using a dial-up, DSL, or cable modem that communicates with the display module 18 or by connecting to a secure Internet web site hosted by the network provider that allows the user to interface with the display module. The security of the secure data link 28 can be provided and maintained using network security capabilities such as intrusion detection, content screening, URL blocking and bandwidth management. Examples of network security capabilities include network protection software, Internet security software, network firewall technology, VPN (Virtual private Network) technology, secured messaging software (i.e., encryption), and URL filtering systems, as is known in the art. The operation of the system 10 is not dependent upon location of the data repository 11 and controller 15 and, thus, the location of these components can vary as necessary due to space or economic considerations.

The processing module 17 and/or the display module 18 can include several menus and submenus through which a user can interact or communicate with the system 10 via the user interface 12. For example, as illustrated in FIG. 2, the menus can include categories such as locating an interactive map, member login (including a corresponding security module (not show), contact information for the parking area owner so that the user can provide comments or request information, or menus relating to payment options, etc.

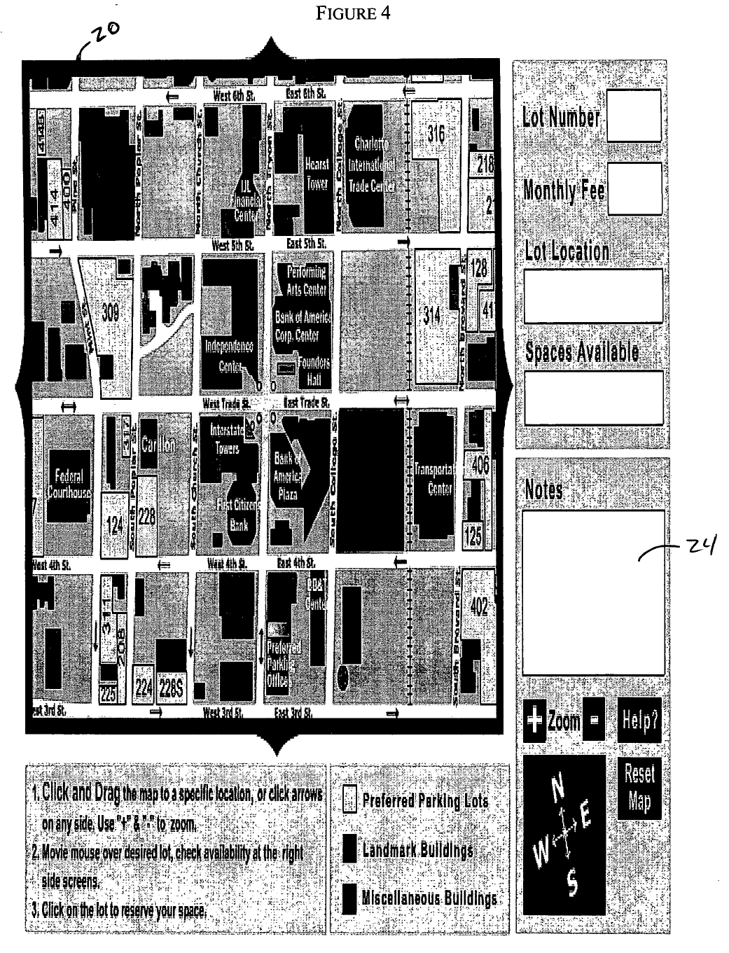

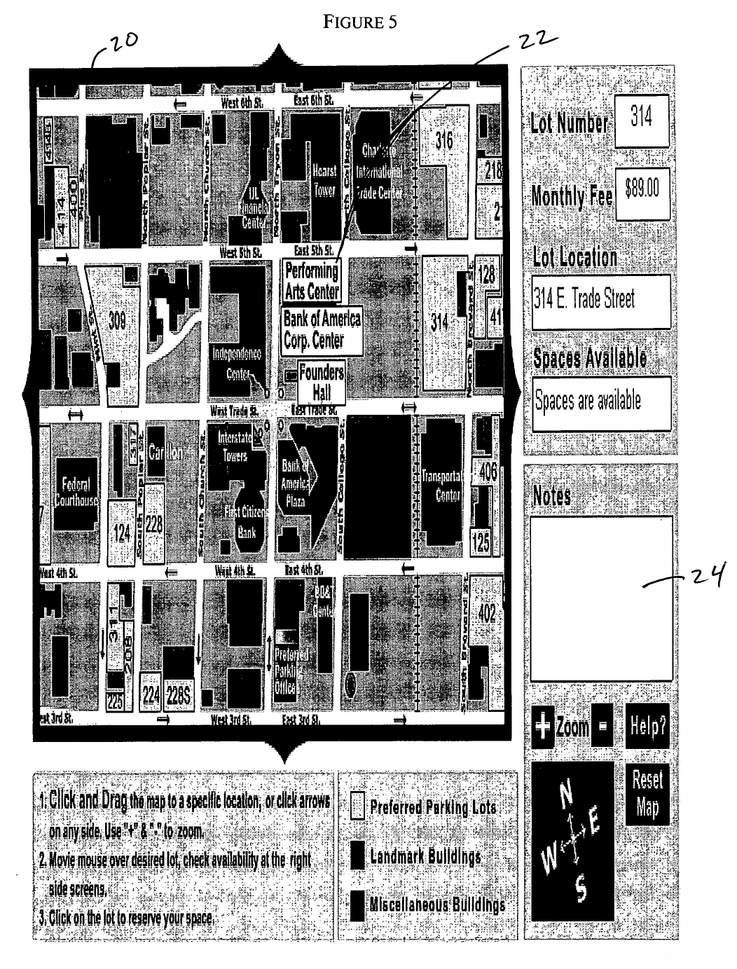

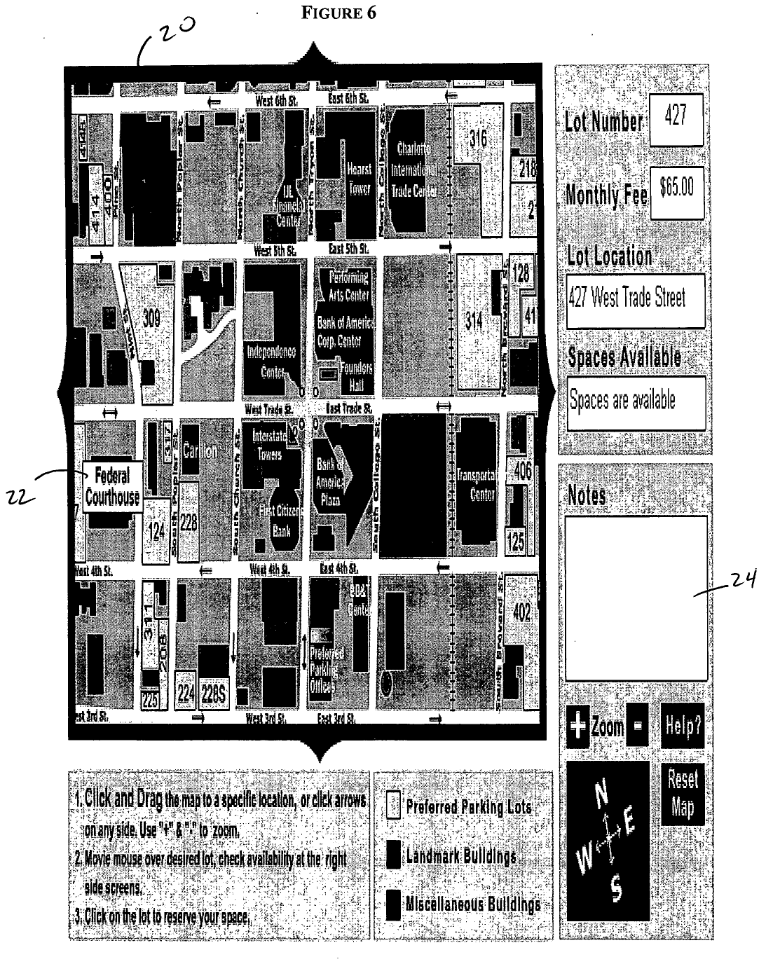

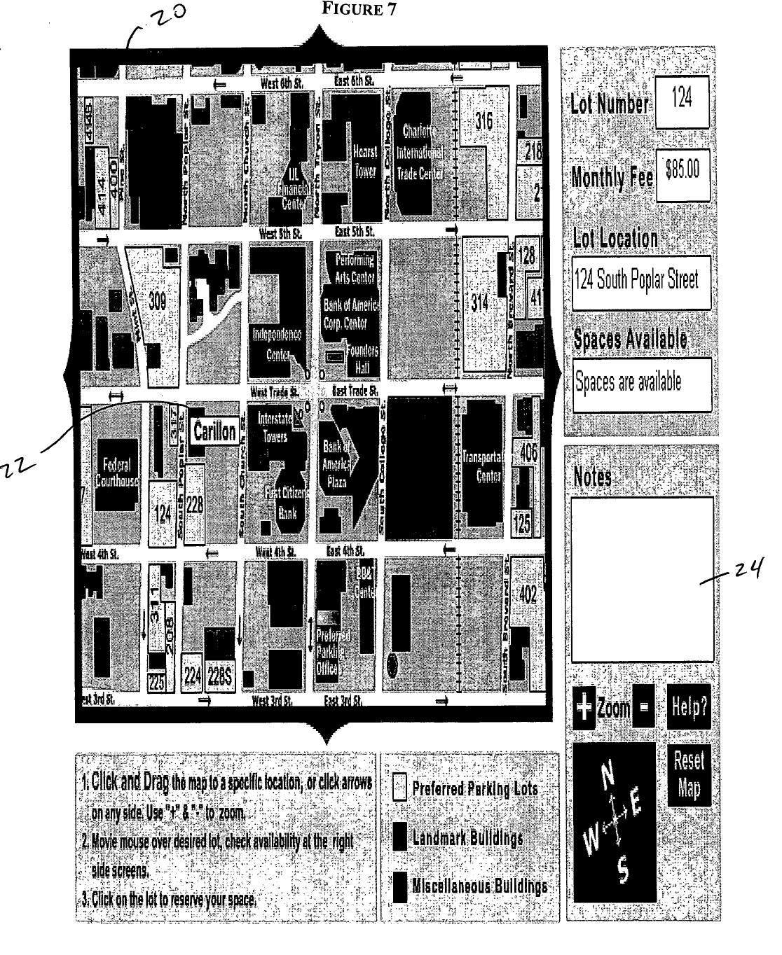

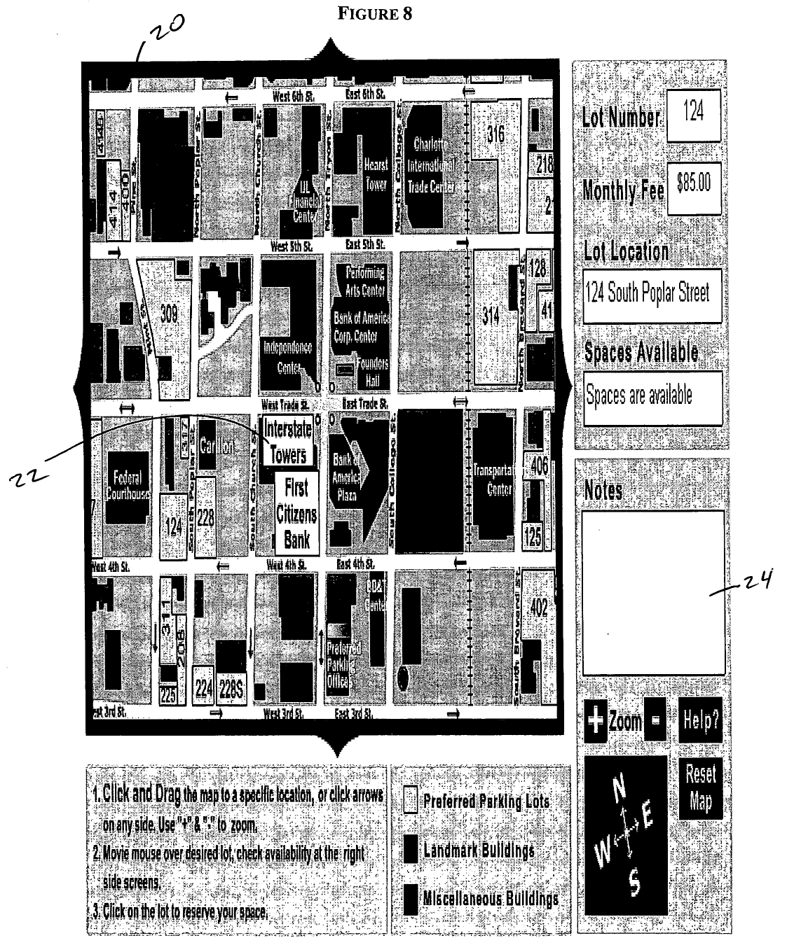

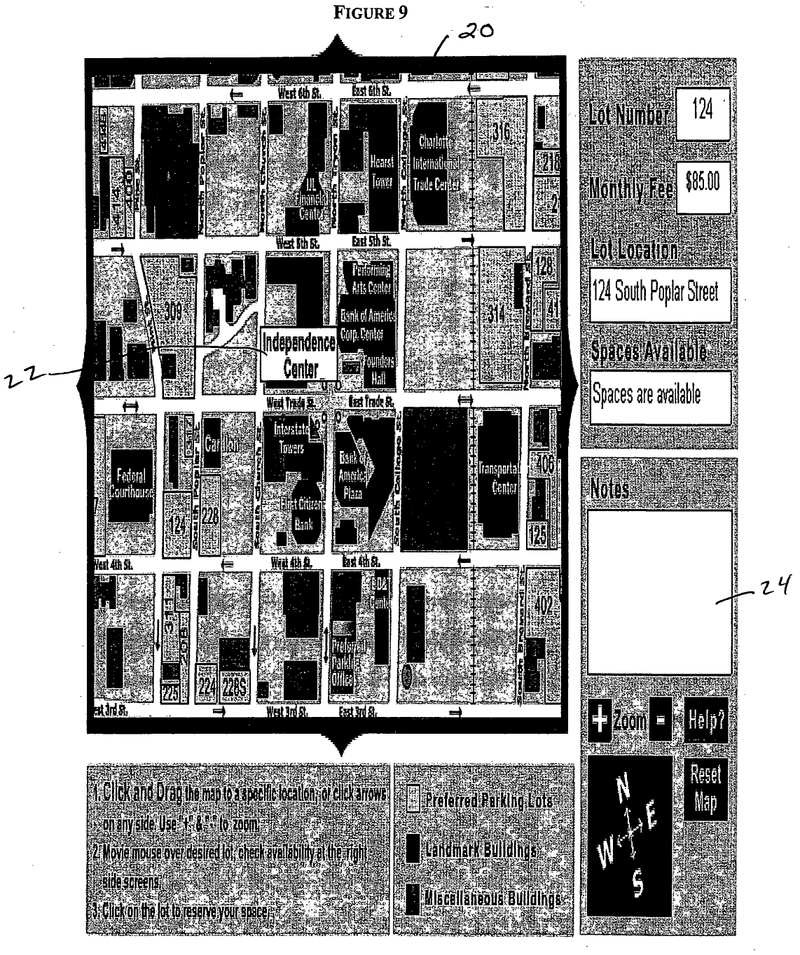

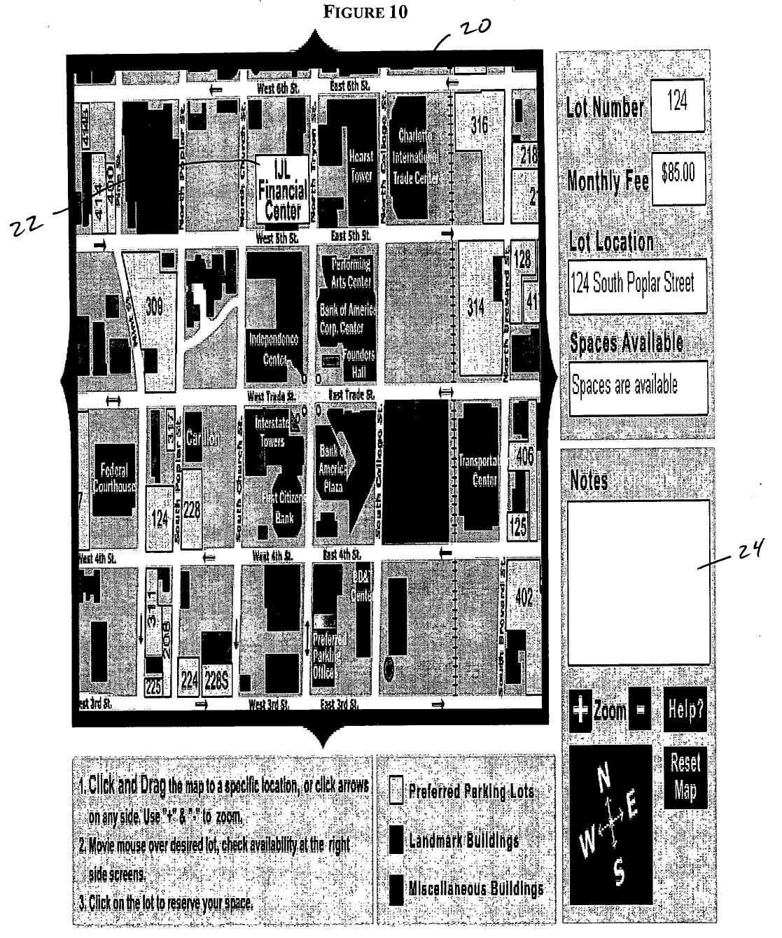

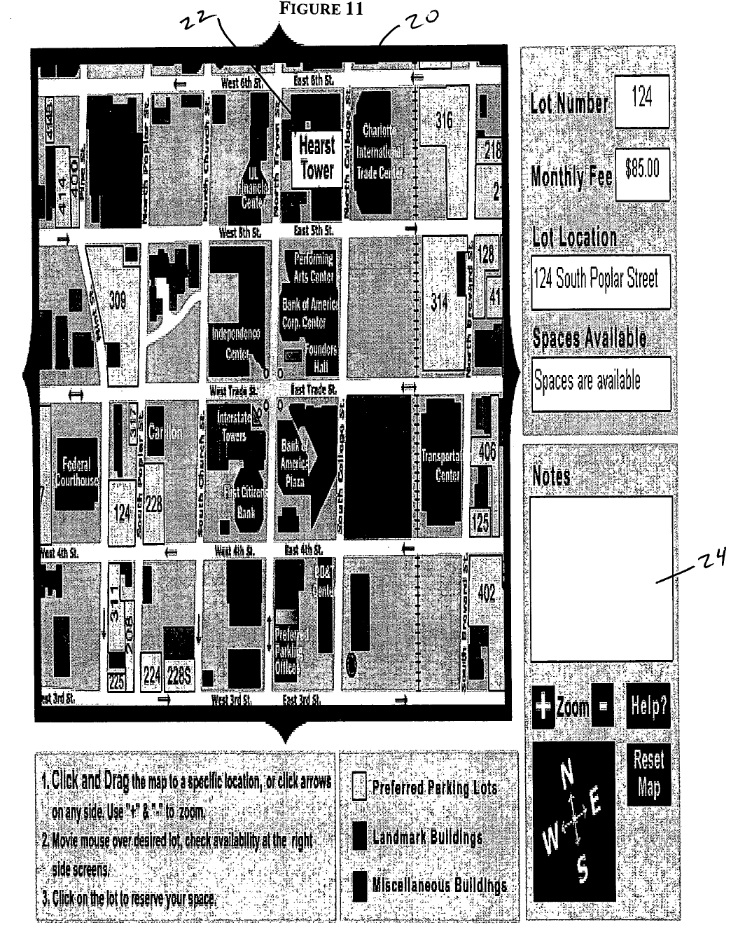

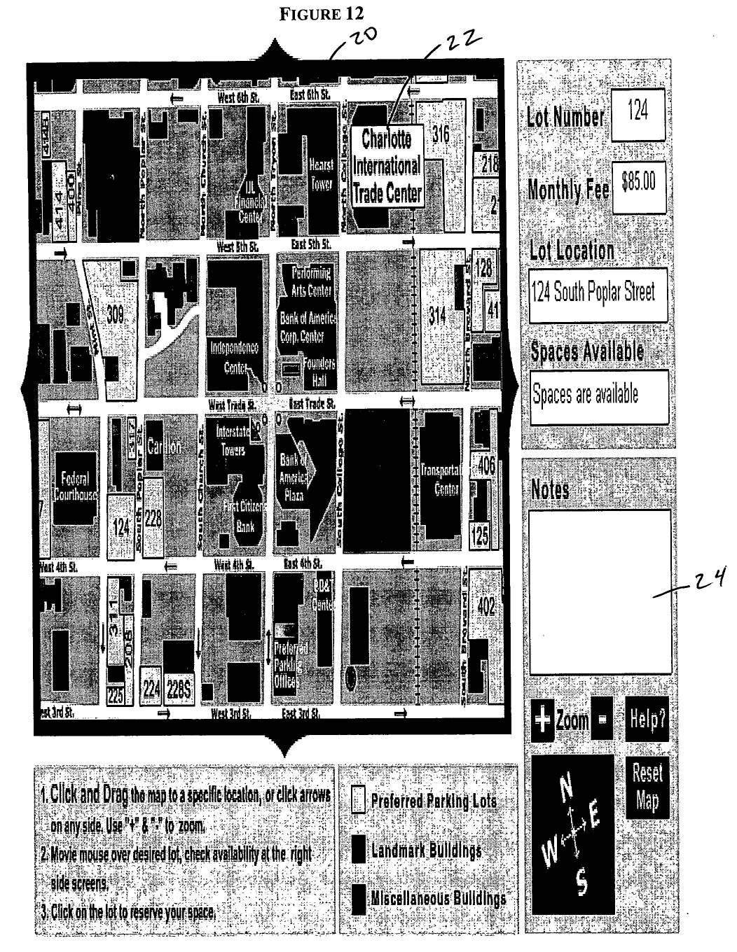

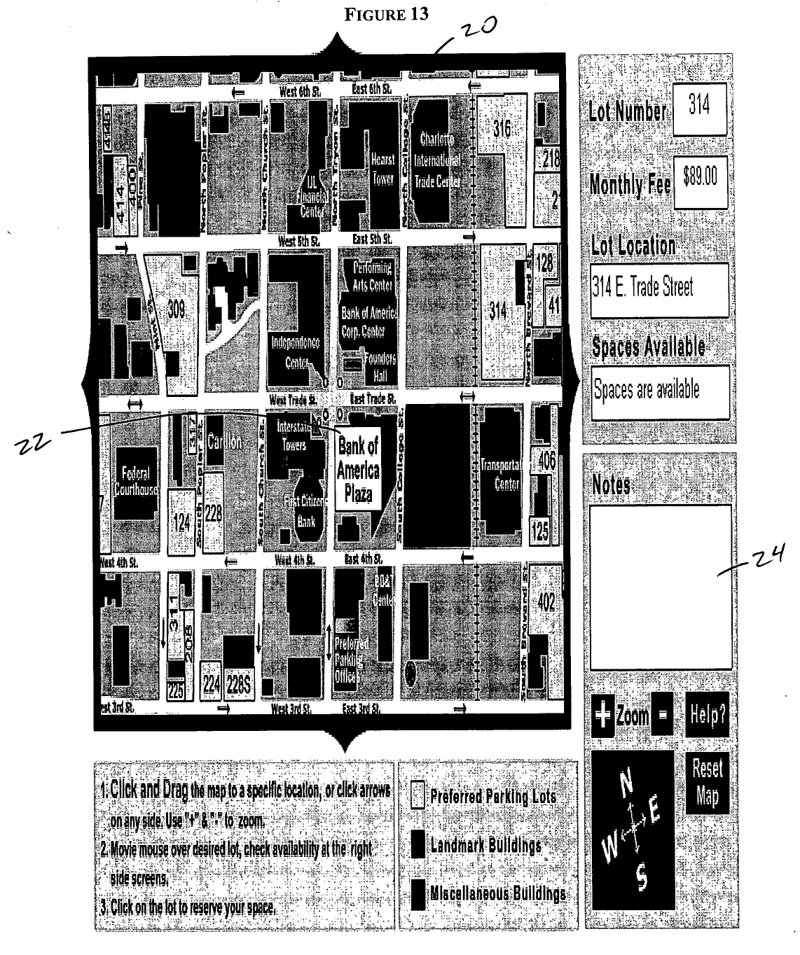

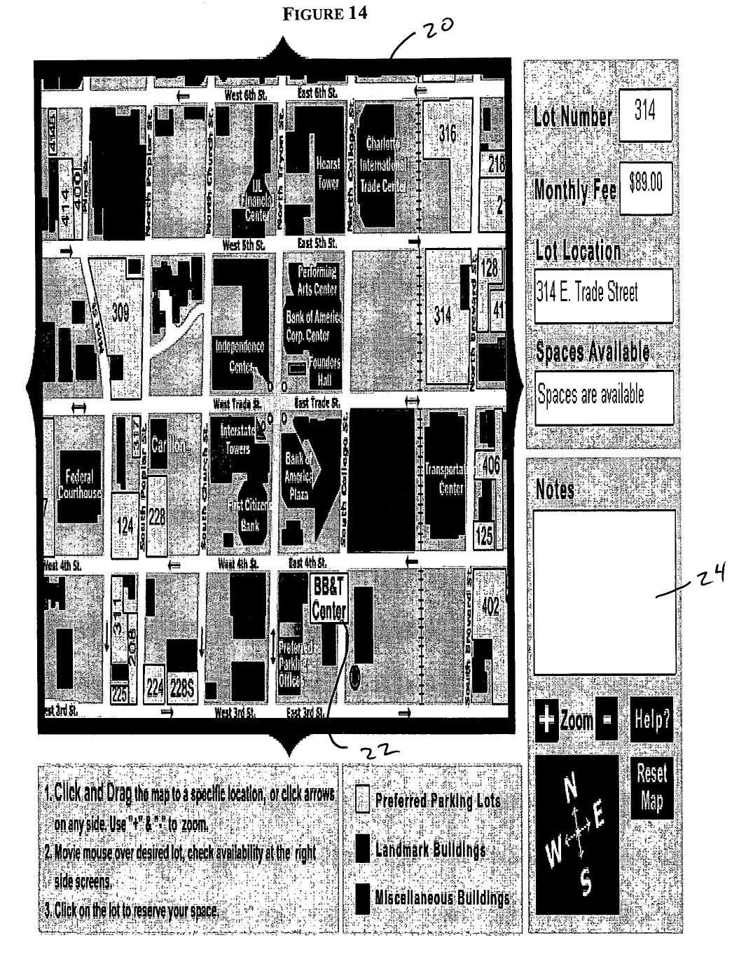

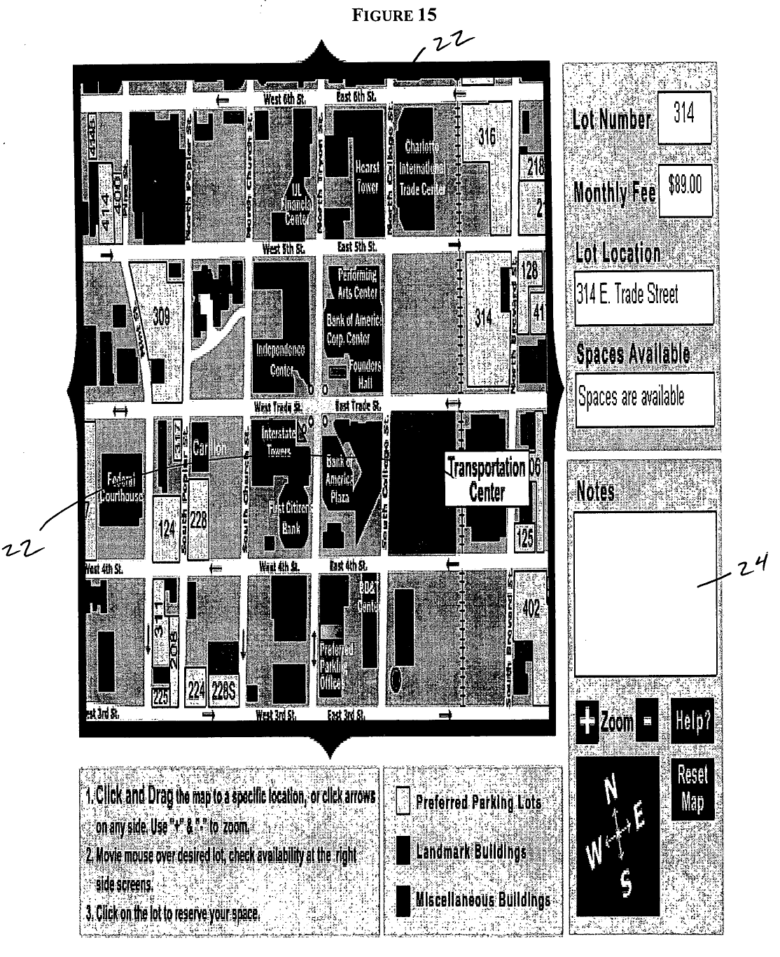

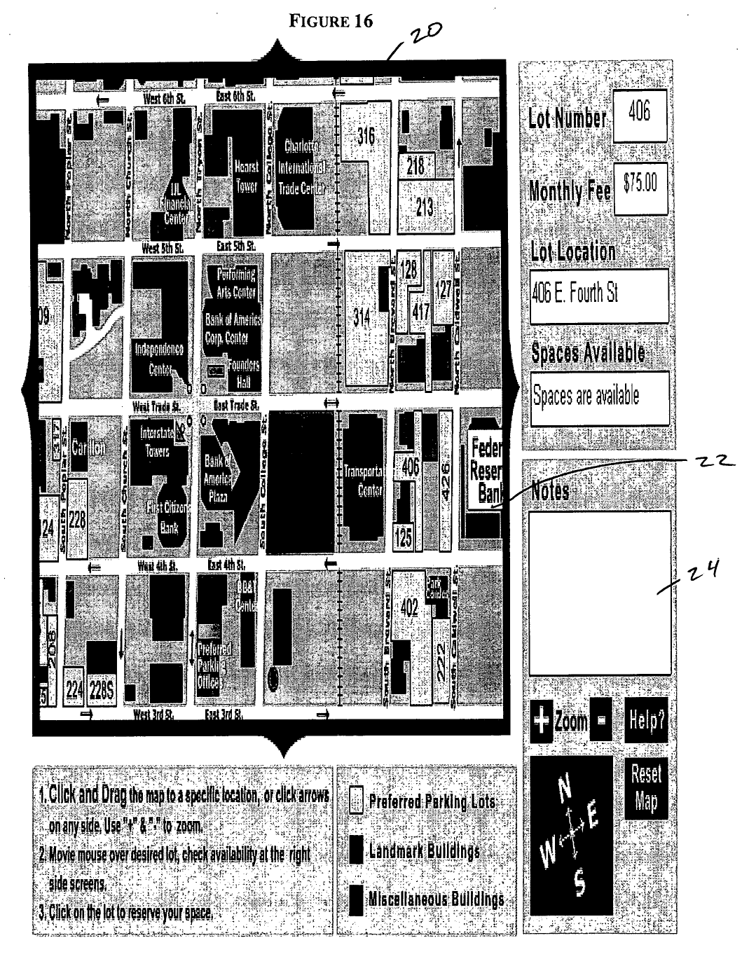

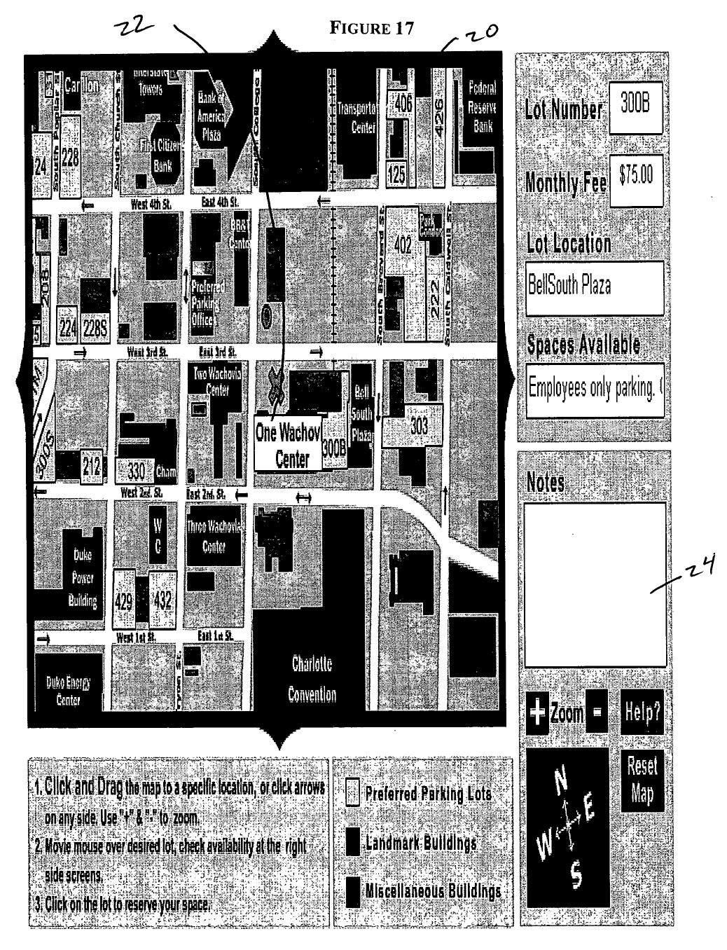

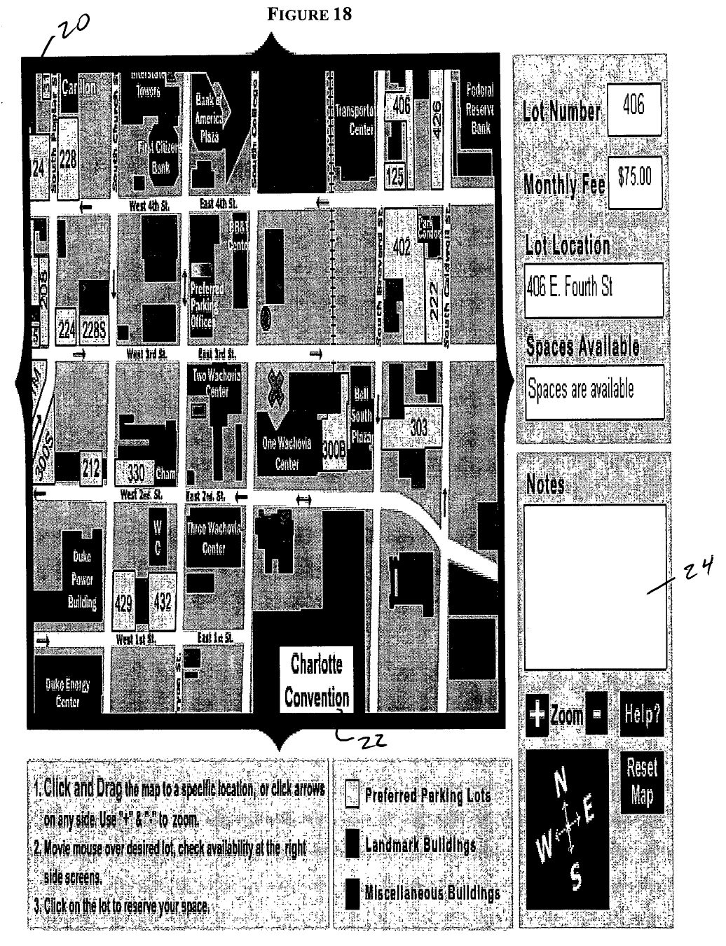

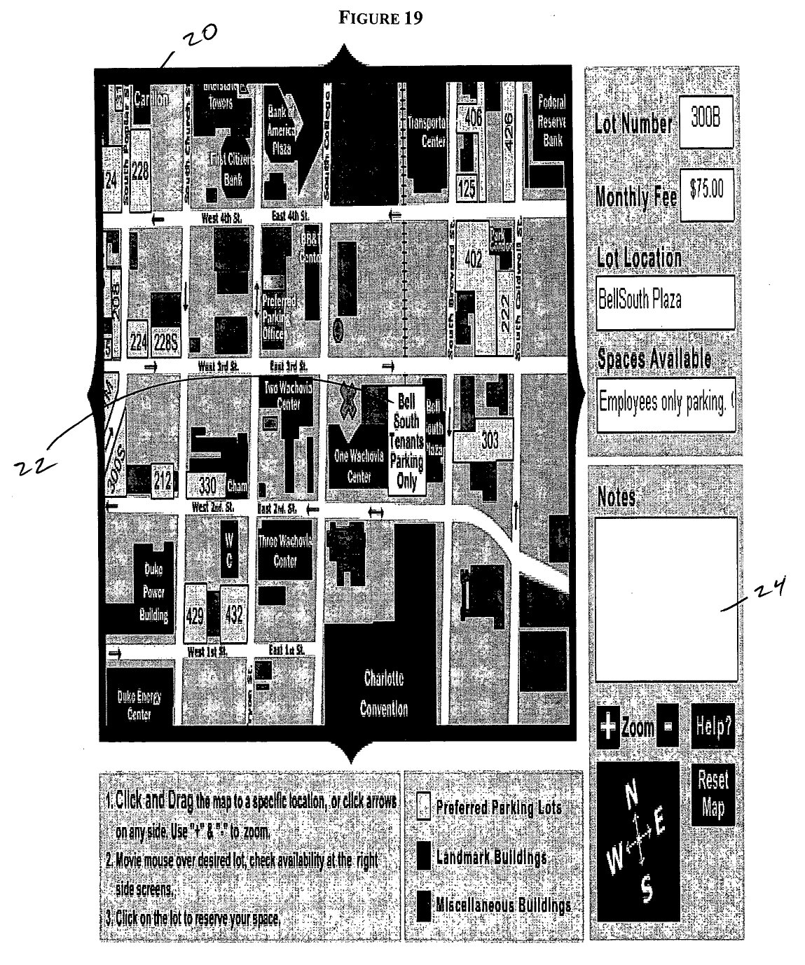

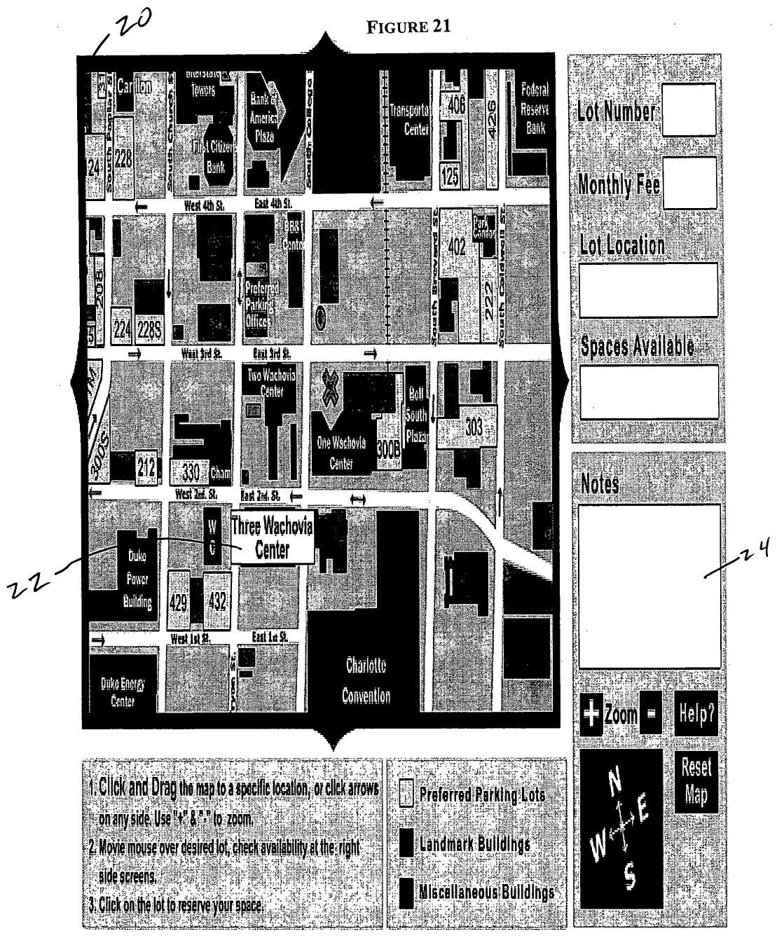

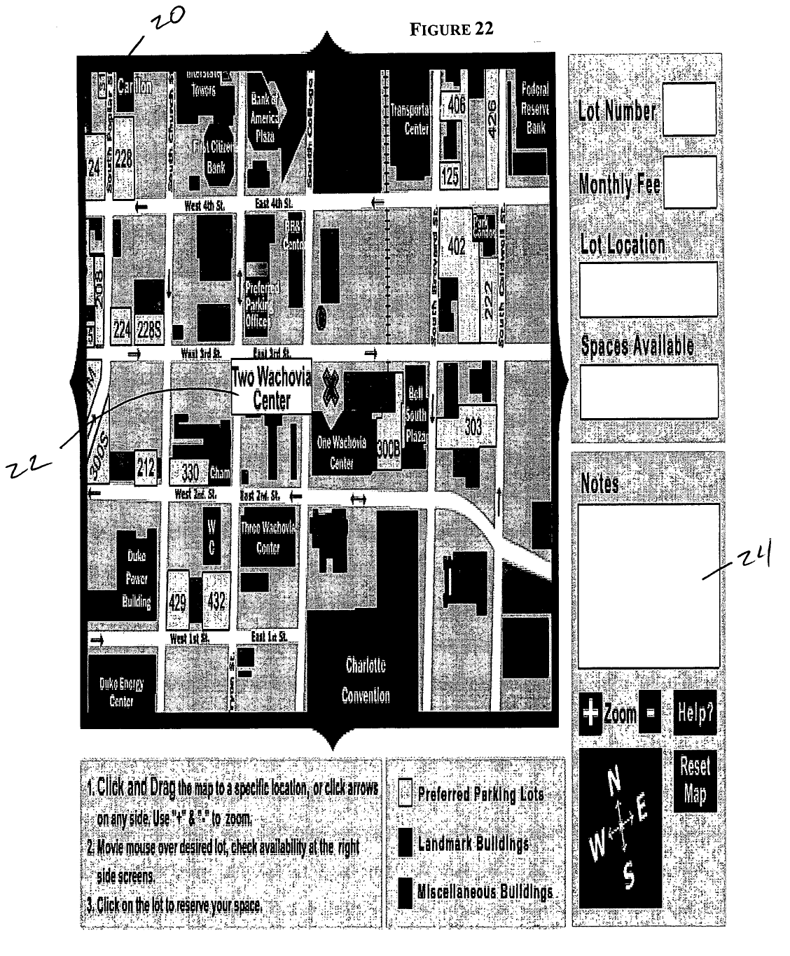

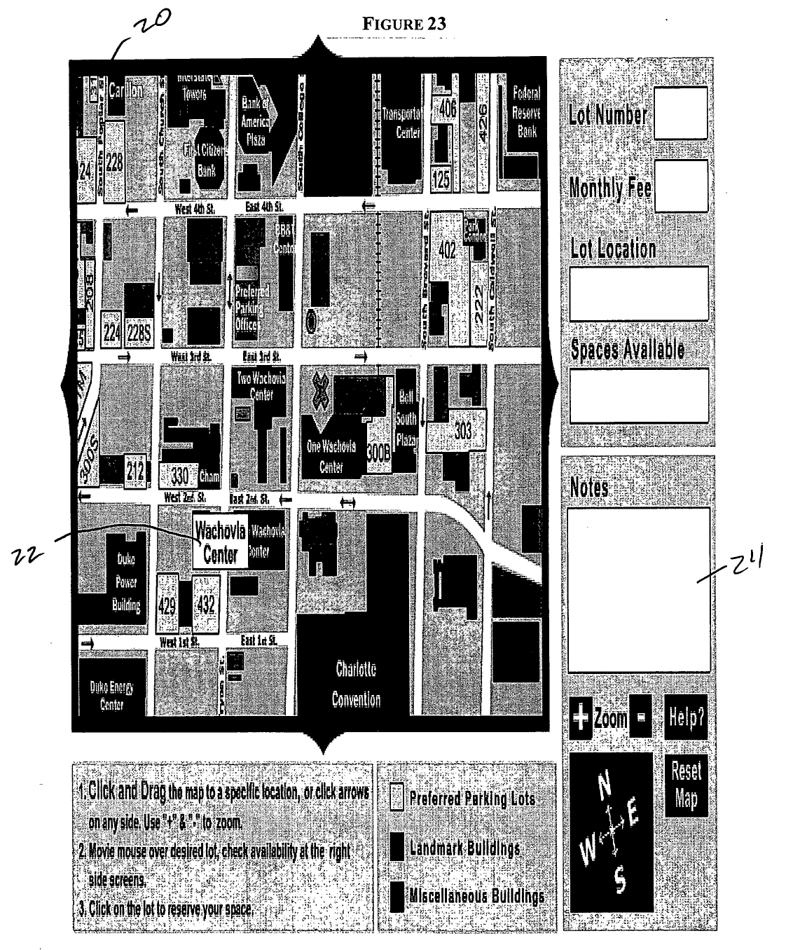

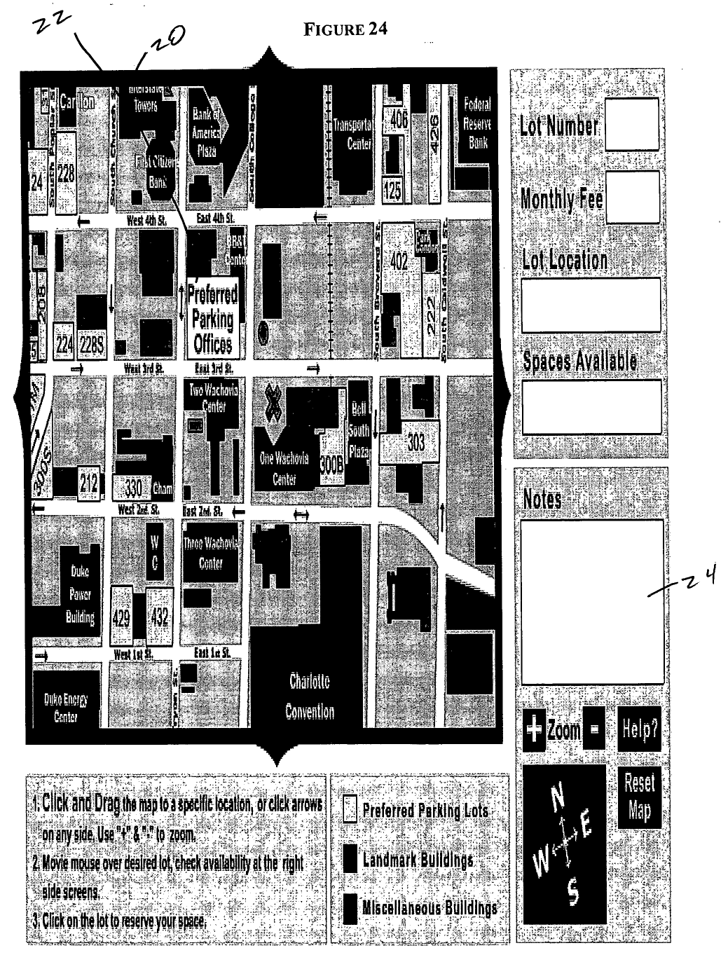

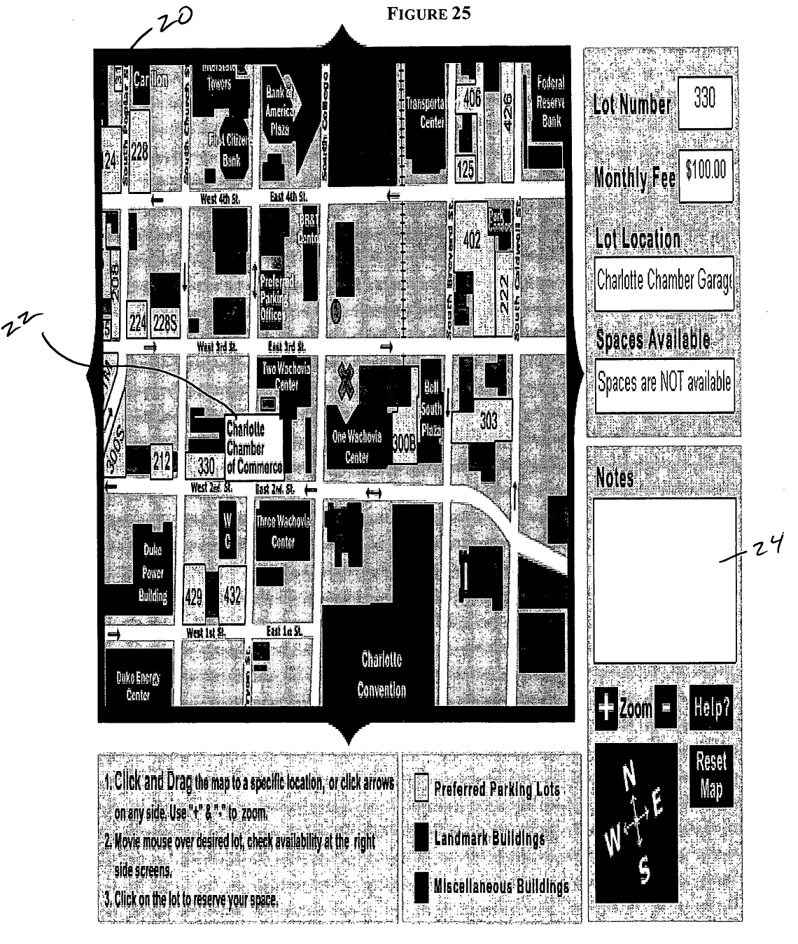

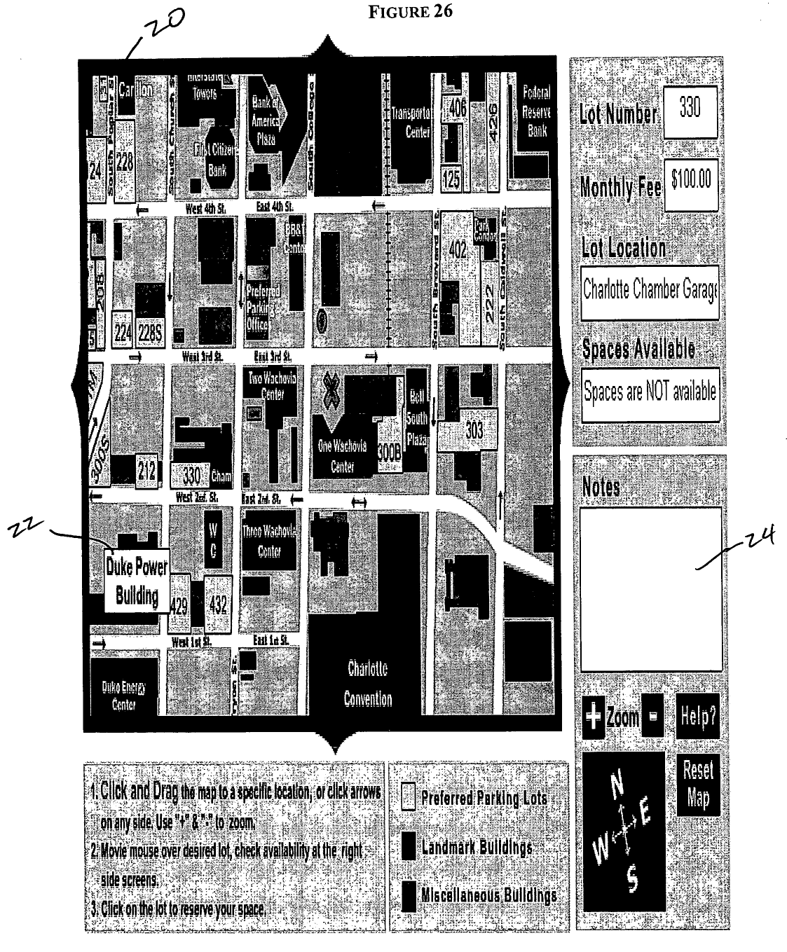

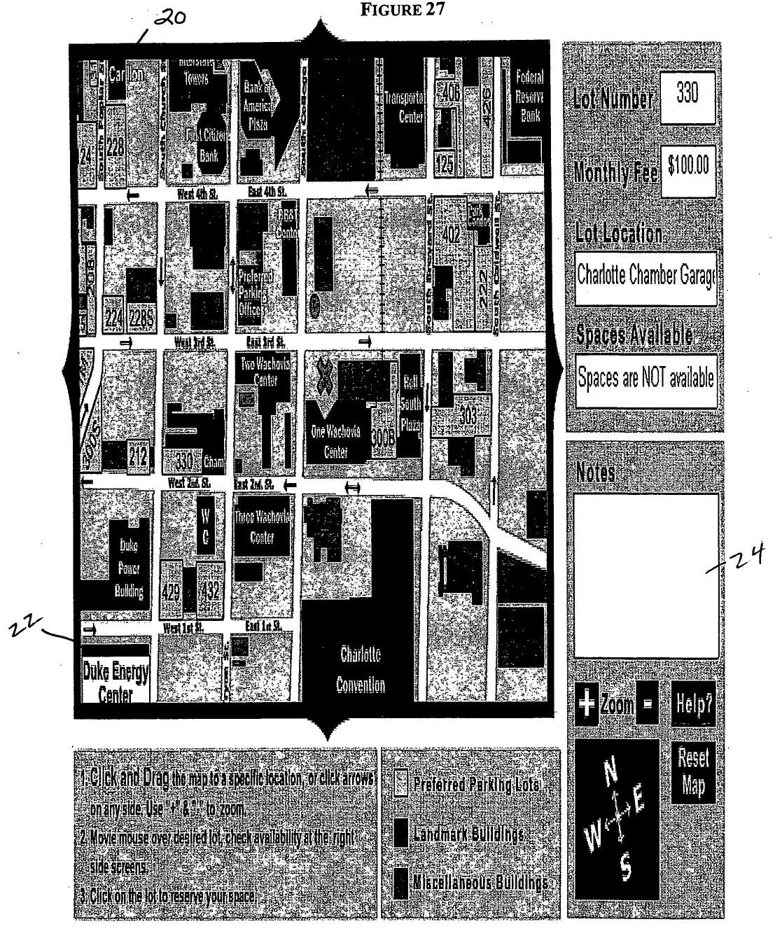

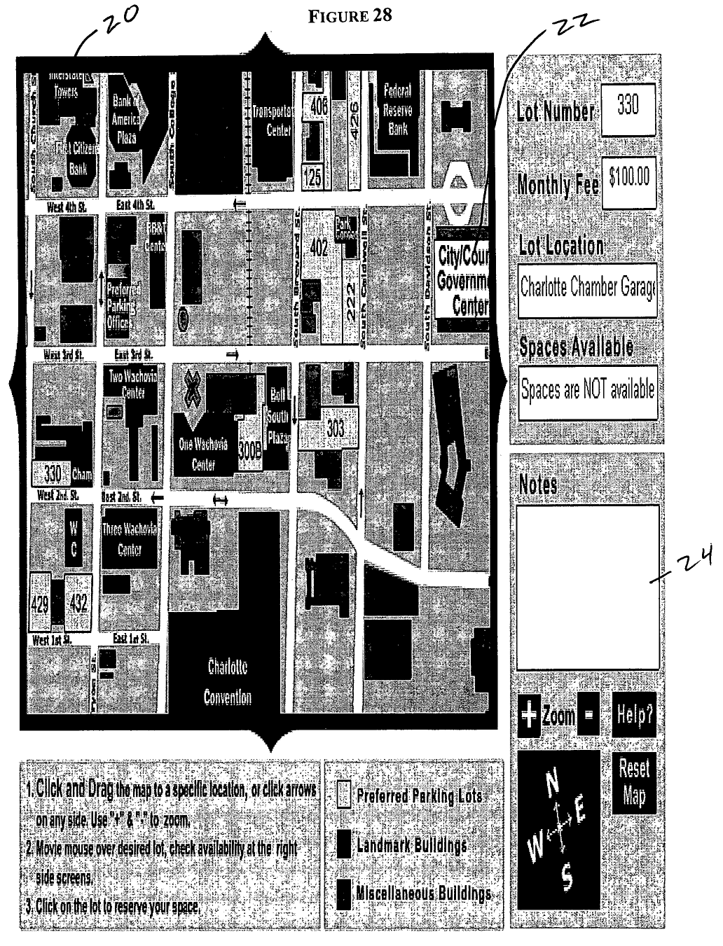

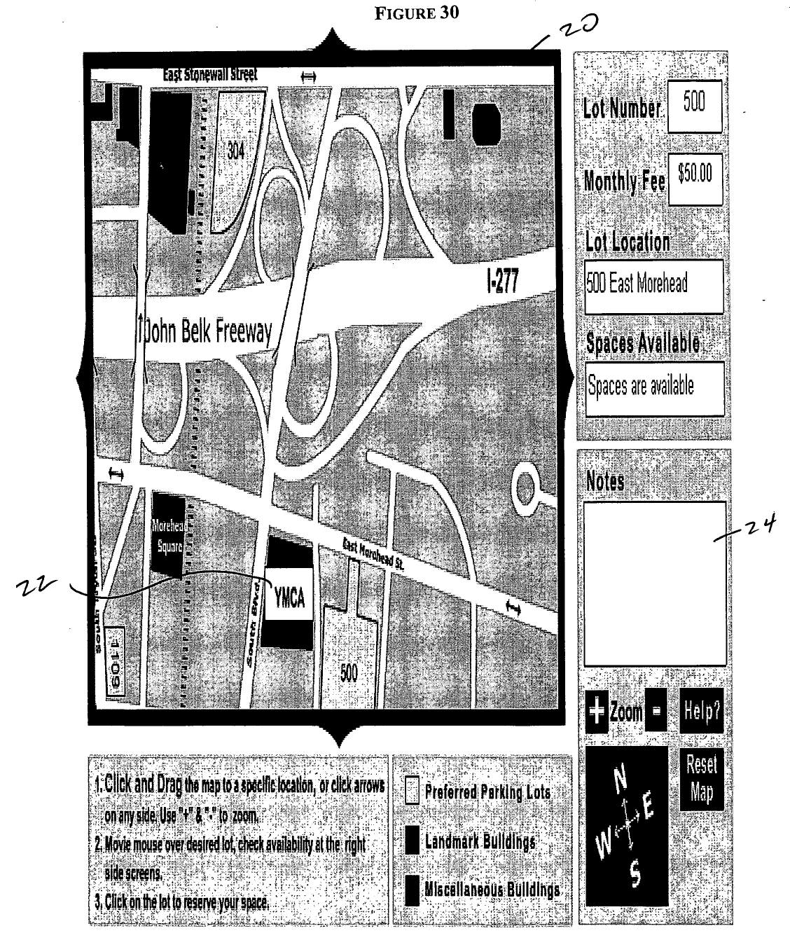

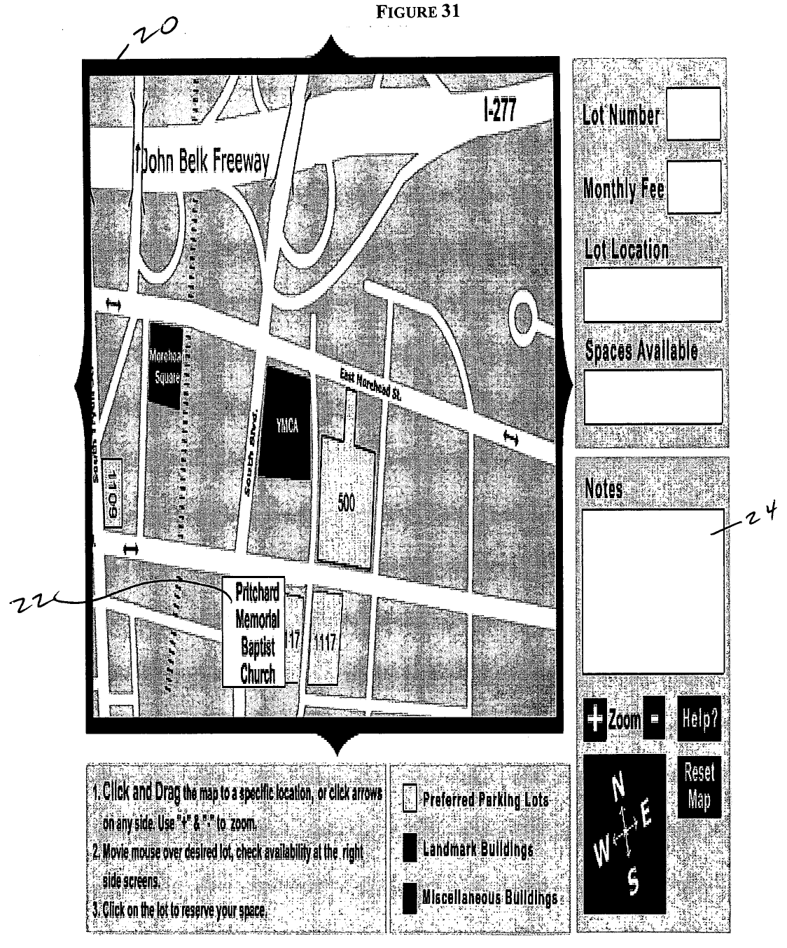

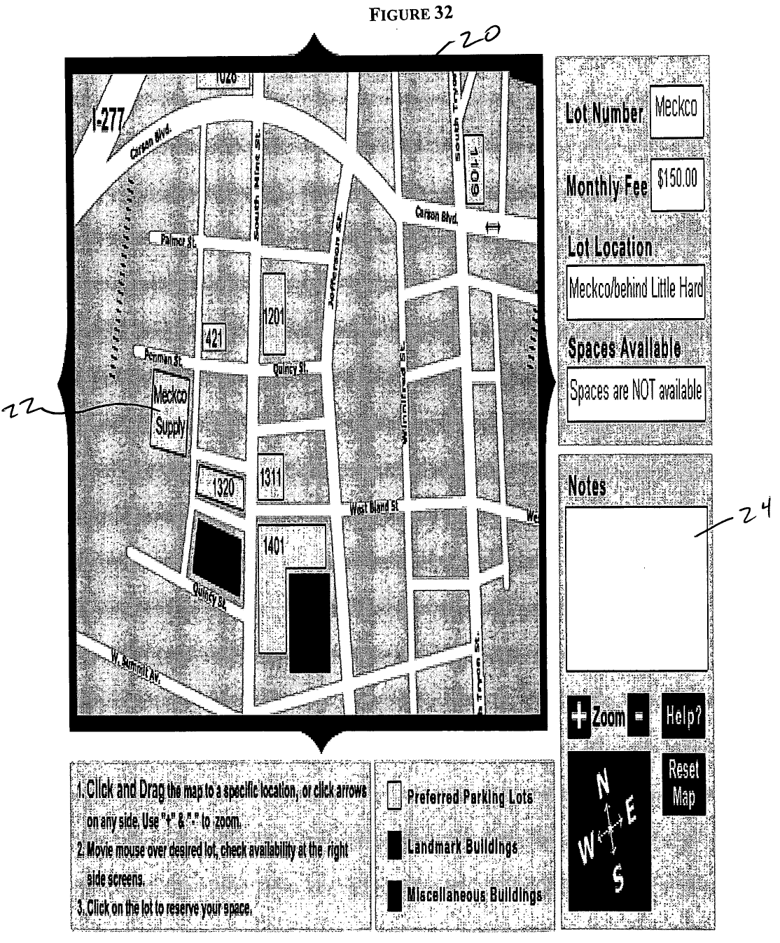

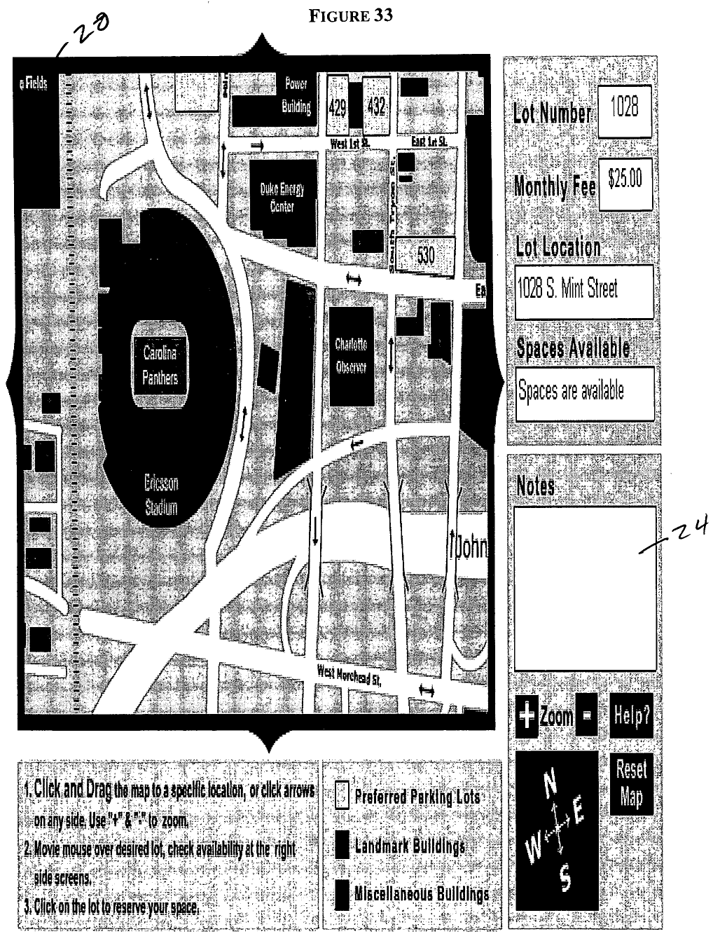

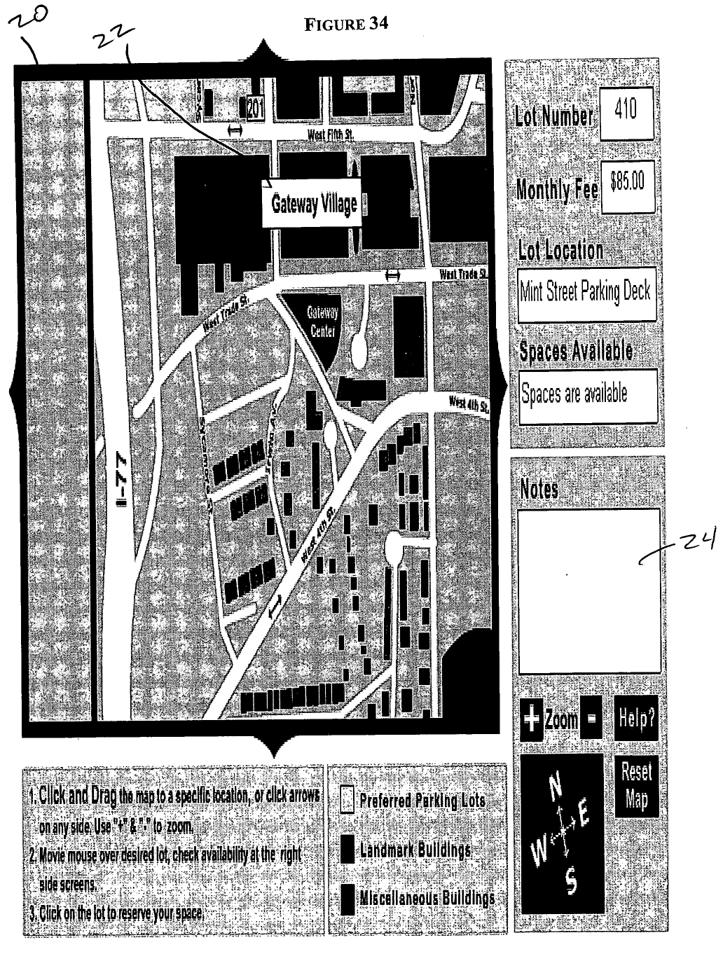

FIGS. 4-34 are diagrams illustrating interactive maps 20 generated and displayed on a user interface 12 by the display module 18 in communication with the processing module 17 and retrieval module 16 of the controller 15 and the data repository 11. As illustrated in FIGS. 4-34, the interactive maps 20 enable a user via the user interface 12 to selectively request geographical information relative to parking and the adjacent locale to enable the user to select parking. Each interactive map 20 preferably comprises one or more user-activated menus or components 22 pertaining to specific geographic areas identified on the interactive map 20. When the user selects a user- activated menu 22 via the user interface 12 (such as by moving a mouse or selecting a key on a key board), which is in operable communication with the controller 15 (including the processing module 17 and/or the display module 18), the retrieval module 16 communicates with the data repository 11 and retrieves data corresponding to the geographic area selected by the user. The data is communicated from the retrieval module 16 to the processing module 17 and/or display module 18 where the data is processed and incorporated into an interactive map 20 that is generated and displayed at the user interface 12 via the display module 18. As illustrated in FIGS. 4-34, the data corresponding to the geographical area can include such information as the name of a particular geographic area, the lot number, the monthly fee, the lot location, the number of spaces available, etc.

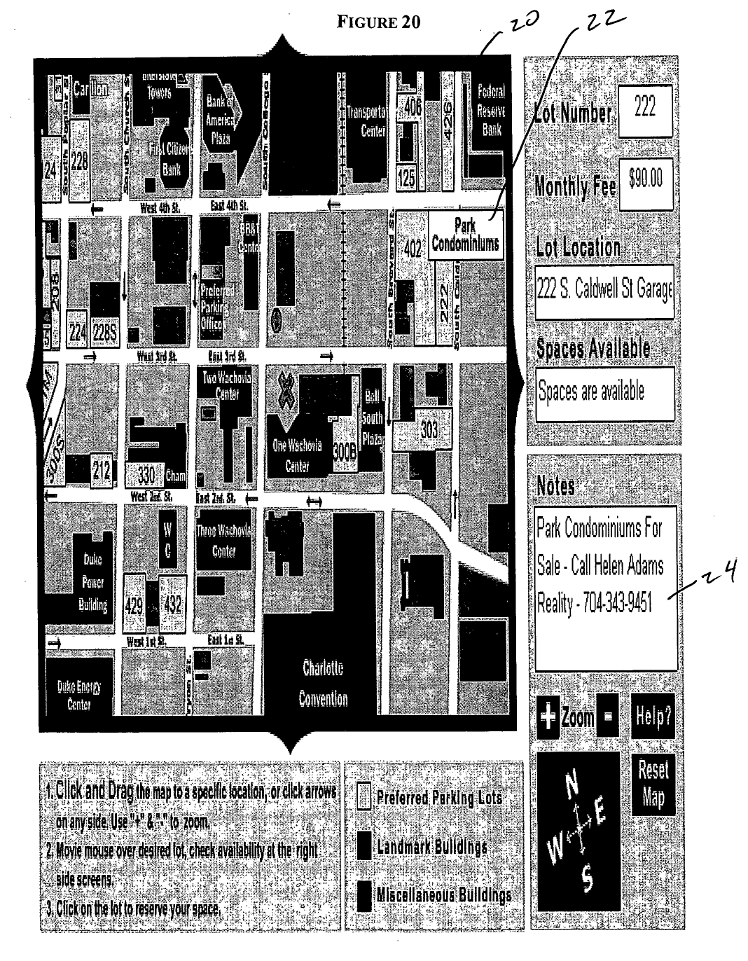

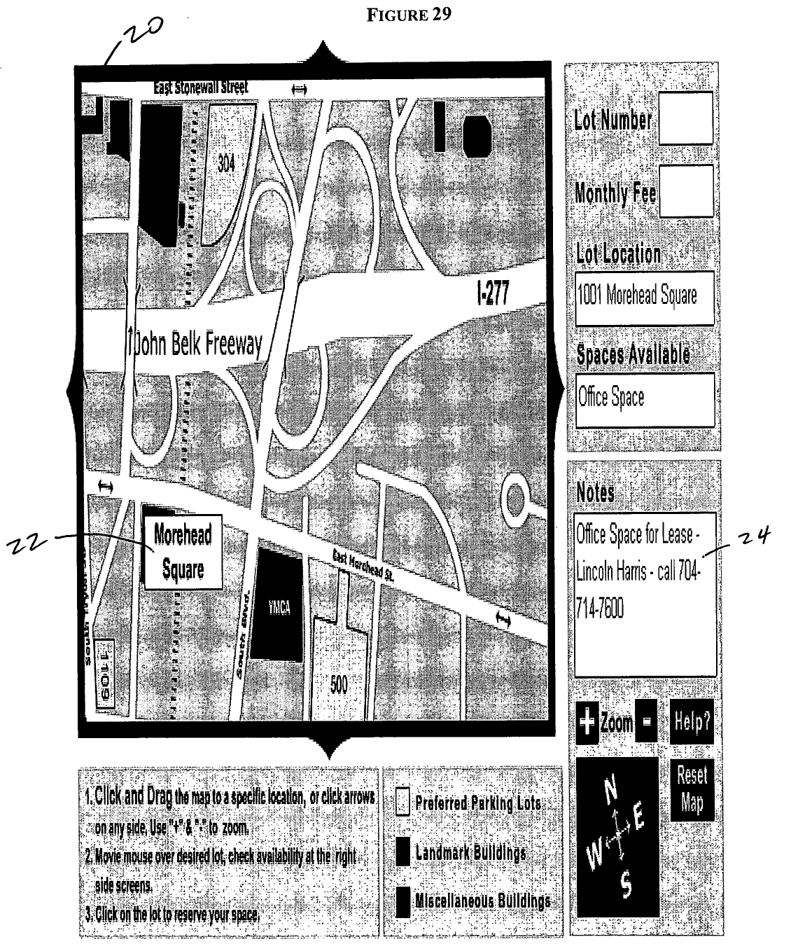

As illustrated in FIGS. 20 and 29, the interactive maps 20 can also include a location 24 to provide advertising (including the name, contact information, etc. of a realtor or sales associate), notations, or other information relative to specific geographic areas. Alternatively, in other embodiments (not shown), the location 24 can be used by the user to record or store notes, which can be stored in computer-readable memory, at least temporarily, by the controller 15 either locally or in communication with the data repository 11. For example, if the user were investigating several parking lots, the user could record information to use in comparing the available spaces, including characteristics of the parking, costs, etc.

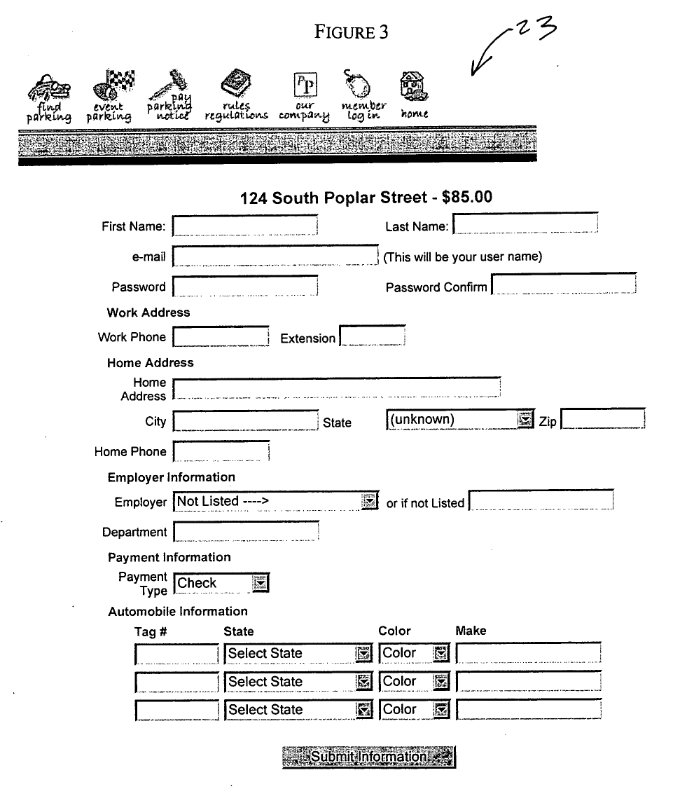

In addition to the interactive maps 20, the display module 18 preferably is also structured to generate and display one or more graphical displays 23, such as the one illustrated in FIG. 3, which can be used to prompt or solicit information from a user through the user interface 12. For example, once the user selects parking, the display module 18 of the controller 15 can generate and display the graphical display 23 illustrated in FIG. 3 in order to obtain an necessary customer information to assign the parking and/or process the customer's payment. The configuration of the graphical display 23 can vary depending on the nature of information being requested from the user.

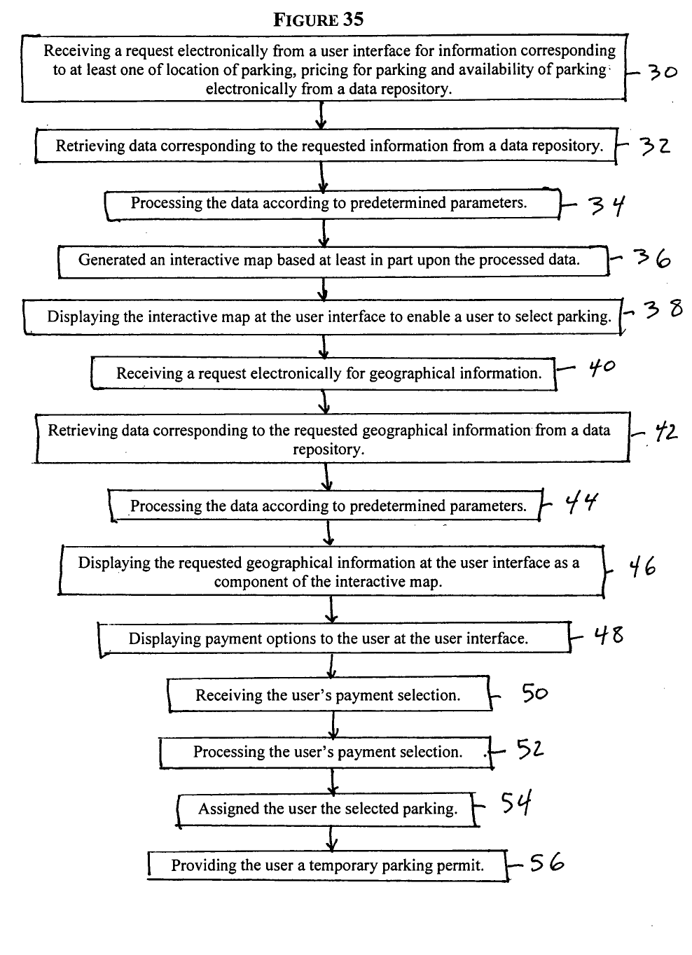

Referring to FIG. 35, there is illustrated a method of selecting and assigning parking, according to one embodiment of the present invention. The method includes receiving a request electronically from a user interface for information corresponding to at least one of location of parking, pricing for parking and availability of parking electronically from a data repository. See Block 30. Data corresponding to the requested information is retrieved from a data repository. See Block 32. The data is processed according to predetermined parameters. See Block 34. An interactive map is generated based at least in part upon the processed data. See Block 36. The interactive map is displayed at the user interface to enable a user to select parking. See Block 38. In one embodiment, the method includes receiving a request electronically for geographical information. See Block 40. Data corresponding to the requested geographical information is retrieved from a data repository. See Block 42. The data is processed according to predetermined parameters. See Block 44. The requested geographical information is displayed at the user interface as a component of the interactive map. See Block 46.

In still other embodiments, the method comprises displaying payment options to the user at the user interface. See Block 48. The user's payment selection is received. See Block 50. The user's payment selection is then processed. See Block 54. In one embodiment, the user is assigned the selected parking. See Block 56. In another embodiment, the user is provided a temporary parking permit. See Block 58.

FIGS. 1, 2, and 35 are block diagrams, flowcharts and control flow illustrations of methods, systems and program products according to the invention. It will be understood that each block or step of the block diagrams, flowcharts and control flow illustrations, and combinations of blocks in the block diagrams, flowcharts and control flow illustrations, can be implemented by computer program instructions. These computer program instructions may be loaded onto, or otherwise executable by, a computer or other programmable apparatus to produce a machine, such that the instructions which execute on the computer or other programmable apparatus create means or devices for implementing the functions specified in the block diagrams, flowcharts or control flow block(s) or step(s). These computer program instructions may also be stored in a computer-readable memory that can direct a computer or other programmable apparatus to function in a particular manner, such that the instructions stored in the computer-readable memory produce an article of manufacture, including instruction means or devices which implement the functions specified in the block diagrams, flowcharts or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagrams, flowcharts or control flow block(s) or step(s).

Accordingly, blocks or steps of the block diagrams, flowcharts or control flow illustrations support combinations of means or devices for performing the specified functions, combinations of steps for performing the specified functions and program instruction means or devices for performing the specified functions. It will also be understood that each block or step of the block diagrams, flowcharts or control flow illustrations, and combinations of blocks or steps in the block diagrams, flowcharts or control flow illustrations, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A system for selecting and assigning parking, comprising:
a data repository electronically retaining location data for parking, pricing data for parking and predetermined geographical data;
at least one user interface having a display; and
a controller interfacing with said data repository and said at least one user interface, said controller comprising:
a retrieval module structured to retrieve data from said data repository;
a processing module interfacing with said retrieval module and being structured to process the data based on predetermined parameters; and
a display module interfacing with said processing module and said at least one user interface and being structured to display the processed data in the form of an interactive map on said display of said at least one user interface whereby the user can selectively request geographical information relative to parking and the adjacent locale to enable the user to select parking.

2. A system according to claim 1 wherein said interactive map comprises user-activated menus containing corresponding geographical information.

3. A system according to claim 1 wherein said display module is structured to display payment options comprising at least one of bank account drafting and credit card processing.

4. A system for facilitating the selection and assignment of parking, the system comprising:
a processing element capable of generating and displaying an interactive map containing available parking for selection by a user, said processing element also is capable of receiving data corresponding to the parking selected by the user, and wherein said processing element is further capable of assigning parking to the user.

5. A system according to claim 4 wherein the interactive map comprises user-activated menus containing corresponding geographical information.

6. A system according to claim 4 wherein said processing element is capable of displaying payment options comprising at least one of bank account drafting and credit card processing.

7. A system according to claim 6 wherein said processing element is capable of receiving data corresponding to the payment option selected by the user, and said processing element also is capable of processing the payment.

8. A system according to claim 4 wherein said processing element is capable of assigning the user the selected parking.

9. A system according to claim 4 wherein said processing element is capable of issuing the user a temporary parking permit.

10. A system for facilitating the selection and assignment of parking, the system comprising:
a processing element capable of receiving a request from a user for selected geographical information, said processing element being capable retrieving data corresponding to the selected geographical information, said processing element being capable of processing the data according to predetermined parameters, and said processing element being capable of generating and displaying the requested geographical information as a component of an interactive map to enable the user to select parking.

11. A system according to claim 10 wherein said processing element is capable of displaying payment options comprising at least one of bank account drafting and credit card processing.

12. A system according to claim 111 wherein said processing element is capable of receiving data corresponding to the payment option selected by the user, and said processing element also is capable of processing the payment.

13. A system according to claim 10 wherein said processing element is capable of assigning the user the selected parking.

14. A system according to claim 10 wherein said processing element is capable of issuing the user a temporary parking permit.

15. A method of selecting and assigning parking, comprising:
receiving a request electronically from a user interface for information corresponding to at least one of location of parking, pricing for parking and availability of parking;
retrieving data corresponding to the requested information from a data repository;
processing the data according to predetermined parameters;
generating an interactive map based at least in part upon the processed data; and
displaying the interactive map at the user interface to enable a user to select parking.

16. A method according to claim 15 further comprising:
receiving a request electronically for geographical information;
retrieving data corresponding to the requested geographical information from a data repository;
processing the data according to predetermined parameters; and
displaying the requested geographical information at the user interface as a component of the interactive map.

17. A method according to claim 15 further comprising displaying payment options to the user at the user interface.

18. A method according to claim 17 further comprising:
receiving the user's payment selection; and
processing the user's payment selection.

19. A method according to claim 15 further comprising assigning the user the selected parking.

20. A method according to claim 15 further comprising issuing to the user a temporary parking permit.

21. A computer program product for facilitating the selection and assignment of parking, the computer program product comprising a computer-readable storage medium having computer-readable program code portions stored therein, the computer- readable program portions comprising:
an executable portion for generating and displaying an interactive map containing available parking for selection by a user, said executable portion receives data corresponding to the parking selected by the user; and wherein said executable portion assigns parking to the user.

22. A computer program product according to claim 21 wherein the interactive map comprises user-activated menus containing corresponding geographical information.

23. A computer program product according to claim 21 wherein said executable portion displays payment options comprising at least one of bank account drafting and credit card processing.

24. A computer program product according to claim 23 wherein said executable portion receives data corresponding to the payment option selected by the user, and said executable portion processes the payment.

25. A computer program product according to claim 21 wherein said executable portion assigns the user the selected parking.

26. A computer program product according to claim 21 wherein said executable portion issues the user a temporary parking permit.

27. A computer program product for facilitating the selection and assignment of parking, the computer program product comprising a computer-readable storage medium having computer-readable program code portions stored therein, the computer-readable program portions comprising:
an executable portion for receiving a request from a user for selected geographical information, said executable portion retrieves data corresponding to the selected geographical information, said executable portion processes the data according to predetermined parameters, said executable portion generates and displays the requested geographical information as a component of an interactive map to enable the user to select parking.

28. A computer program product according to claim 27 wherein said executable portion displays payment options comprising at least one of bank account drafting and credit card processing.

29. A computer program product according to claim 28 wherein said executable portion receives data corresponding to the payment option selected by the user, and said executable portion processes the payment.

30. A computer program product according to claim 27 wherein said executable portion assigns the user the selected parking.

31. A computer program product according to claim 27 wherein said executable portion issues the user a temporary parking permit.
